(19) United States
(12) Patent Application Publication
(10) Pub. No.: US 2007/0219879 A1
(43) Pub. Date: Sep. 20, 2007

(54) System and method for automatically generating expense reports

(76) Inventors: Tarri E. Furlong, San Leandro, CA (US); Sou-Yen Jeffrey Yeh, Sunnyvale, CA (US)

Correspondence Address: CSA LLP, 4807 SPICEWOOD SPRINGS RD., BLDG. 4, SUITE 201, AUSTIN, TX, 78759, US

(21) Appl. No.: 10/769,117

(22) Filed: Jan. 29, 2004

Related U.S. Application Data
(63) Continuation of application No. 09/725,895, filed on Nov. 30, 2000, now abandoned.
(60) Provisional application No. 60/168,219, filed on Nov. 30, 1999.

(51) Int. Cl. G07F 19/00

(52) U.S. Cl. 705/30

(57) ABSTRACT

A system and method for enabling a user to automatically generate an expense report is provided. The system and method enable a user to track daily activities and tasks that can be associated with expenses. When the user desires to generate an expense report, the expenses associated with activities and tasks are collected into an expense report that is generated automatically. According to the present invention, daily activities and tasks are represented by activity item types, instances of which are activity items, and are associated with expenses. Expenses are represented by expense item types, instances of which are expense items. Through the association of activity items and expense items, expense reports can be generated automatically. An exemplary method of generating an expense report according to an embodiment of the invention includes providing a user with a list of activity item types, receiving a signal indicating an activity item, associating the activity item with an expense item, and generating an expense report including the expense item.

### CROSS-REFERENCE TO RELATED APPLICATIONS

This patent application claims priority to U.S. Provisional Patent Application No. 60/168,219, filed Nov. 30, 1999 and entitled “One Button Expense Account System and Method,” the entirety of which is incorporated herein by reference.

### BACKGROUND OF THE INVENTION

1. Field of the Invention

The present invention relates generally to organization management technology, and more particularly, to network-based systems and methods for sales force management.

2. Discussion of the Related Art

Sales management technology has grown up in the era of large multinational organizations. Often, such large organizations require large sales forces, the management and performance of which is often a critical component of a corporation's success. As a result, organizations have sought to improve the process by which sales professionals practice their craft through the use of sales management applications. Sales management applications enable organizations to define, manage, and track the implementation of the sales process. Consequently, an organization is able to constructively guide the daily activities of a sales professional to the betterment of the organization.

The daily activities of a sales professional often involve meetings with clients, entertainment, travel, meals, hotels, parking, taxis, etc. Related to the daily activities, of course, are expenses. Indeed, the operation of a large sales force is a costly, but critical, proposition for any organization. Typically, sales professionals are responsible for tracking their own expenses. In other words, sales professionals pursue sales activities and incur expenses, which are usually charged against either an expense account or personal funds for later reimbursement. In either case, after the expenses are incurred, the sales professional is responsible for submitting an expense report to justify the expense and subsequent reimbursement.

In practice, expense reports can be the bane of a sales professional's existence. In order to complete an expense report, a sales professional must usually track each expense, its value, the reason and date it was incurred, the associated client, and keep a receipt. Often, however, a sales professional may not keep a record of an expense, and may complete an expense report long after the expense was incurred. As a result, accurate and complete expense reports are difficult to generate, resulting in losses to the sales professional.

Not only are expense reports difficult to complete, they are also costly to both the organization and the sales professional. Sales professionals spend time reconstructing the events of the past expense report period, attempting to complete an expense report, rather than pursuing additional sales. The resultant expense report, often fraught with human error, must then navigate the approval process. Managers, accountants and others within the organization subject the expense report to scrutiny, often rejecting an expense report as being incomplete or inaccurate, and returning the report to the sales professional for correction and resubmission.

Accordingly, there is a need for improved mechanisms for creating expense reports. In particular, there is a need for improved systems and methods for tracking the activities of a sales professional, associating expenses with those activities, and automatically generating one or more corresponding expense reports.

### SUMMARY OF THE INVENTION

The present invention addresses the drawbacks of conventional expense report generation by providing a system and method that enables a user to generate an expense report automatically.

Generally, the present invention provides a system and method that enables a user to track daily activities and tasks. The daily activities and tasks can be associated with expenses. When the user desires to generate an expense report, the expenses associated with activities and tasks are collected into an expense report that is generated automatically. According to the present invention, daily activities and tasks are represented by activity item types, instances of which are activity items, and are associated with expenses. Expenses are represented by expense item types, instances of which are expense items. Through the association of activity items and expense items, expense reports can be generated automatically.

An exemplary method of generating an expense report according to an embodiment of the invention includes providing a user with a list of activity item types, receiving a signal indicating an activity item, associating the activity item with an expense item, and generating an expense report including the expense item. Advantageously, generating the expense report occurs in response to a single user action. Examples of a single user action include clicking a mouse button while a cursor is positioned over a predefined area of an information display, speaking a sound, etc. Additionally, the activity item may be added to a second list, such as a calendar or daily planner. The activity item may be provided to a client by transmitting it via a network, and associating it with date information. Generating the expense report may further include validating information associated with the included expense item.

These and other features and advantages of the invention are described hereinafter with reference to a number of exemplary embodiments depicted in the accompanying drawings. Those of skill in the art will appreciate that the exemplary embodiments are provided by way of illustration only, and that the numerous equivalent embodiments are also contemplated herein.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 illustrates an exemplary system according to an embodiment of the invention.

FIGS. 2A-2B illustrate an exemplary activity item and list according to an embodiment of the invention.

FIGS. 3-6 are flow charts illustrating exemplary methods according to an embodiment of the invention.

### DETAILED DESCRIPTION

The present invention is discussed below with respect to various explanatory embodiments. While specific implementations are discussed, it should be understood that this is done for illustrative purposes only. Various features of the present invention may be extended to other applications and embodiments, as would be apparent.

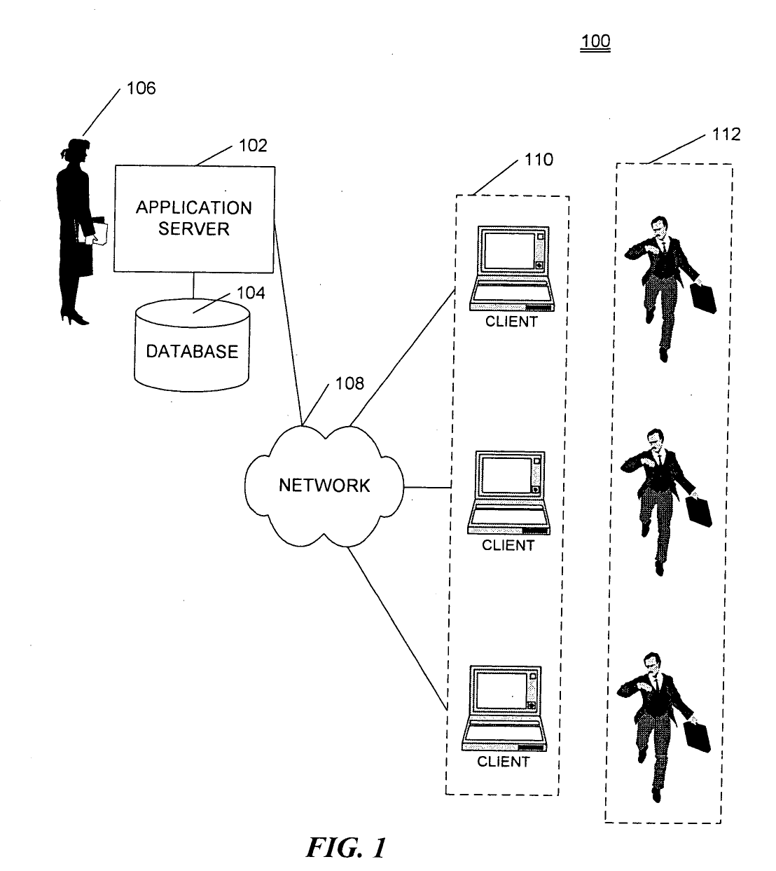

FIG. 1 depicts an exemplary system 100 according to embodiments of the invention. As shown, system 100 includes application server 102, database 104, network 108, and clients 110. In operation, application server 102 and clients 110 execute a sales management application that provides the features and functionality described below. Application server 102 may be any device capable of providing an execution platform for the sales management application. Examples of application server 102 are personal computers (“PCs”), mainframes, minicomputers, etc. Database 104 stores the information for the operation of application server 102. Database 104 may be any data storage system, such as Oracle™, SQL Server™, files, directories, etc. An application administrator 106 interacts with the sales management application on application server 102, providing for data entry, administration, and other tasks as described in further detail below. It should be noted that although application administrator 106 is shown as interacting with application server 102 directly, application administrator 106 may interact with application server 102 via a client, such another one of client such as those shown in element 110.

As shown, application server 102 communicates with clients 110 via network 108. Network 108 can be any data communication network, such as the Internet, a wireless network, a local area network, a wide area network, an intranet, etc. Application server 102 provides sales management application functionality to clients 110 for users 112 as described in further detail below. Client 110 can be any computing platform capable of interacting with application server 102. Clients 110 can include, for example, PCs, notebook computers, wireless personal digital assistants (“PDAs”), network enabled phones, etc. Users 112 may be anyone that interacts with client 110, such as a sales professional, an administrator, a secretary, etc. User 112 accesses the sales management application executing on application server 102 via network 108 using client 110.

Conventionally, users 112 generate expense reports manually, as described above in the Background of the Invention. System 100, however, provides a system and method for generating expense reports automatically when user 112 selects an element (e.g., a button on a graphical user interface, presented to user 112 via client 110). It should be understood that although the present invention is described in terms of a graphical user interface button, a wide array of user interactions with system 100 are contemplated, such as clicking a mouse button, tapping or touching a screen, making a sound (e.g., speech), pressing a key on a keypad, pressing a button on a remote control, etc.

Generally, system 100 provides “personal organizer” features and functionality to user 112. Personal organizer features and functionality preferably include contact lists, contact management, time management, and daily calendar/planner type functionality. User 112 keeps track of daily activities and tasks using system 100. Each of the daily activities and tasks may have associated expenses that are also tracked on system 100. When, the user wishes to generate an expense report, the expenses associated with the user's activities and tasks are collected into an expense report that is generated automatically. It should be noted that although system 100 is depicted as including a client/server architecture, the present invention also contemplates a system implemented on a standalone computer, such as a PC, or PDA.

User 112 interacts with system 100 through client 110. Specifically, user 112 maintains their own list of activity items on client 110. Activity items are tasks user 112 intends to accomplish or has already accomplished. Examples of activity items are meetings, presentations, trips, demonstrations, drafting correspondence, etc. According to an exemplary embodiment, an activity item is part of the sales process and, therefore, business related. In an exemplary embodiment, application administrator 106 predefines the types of activity items that are available to user 112 at client 110. For example, when user 112 adds an activity item to their list, a particular activity item is chosen from among the types of activity items available in the system as predefined by application administrator 106. Administrators can also define the types of expenses that can be associated with a particular activity item. In this way, when that activity type is selected, it is automatically associated with a particular type of expense. Similarly, the user can associate types of expenses with activity items.

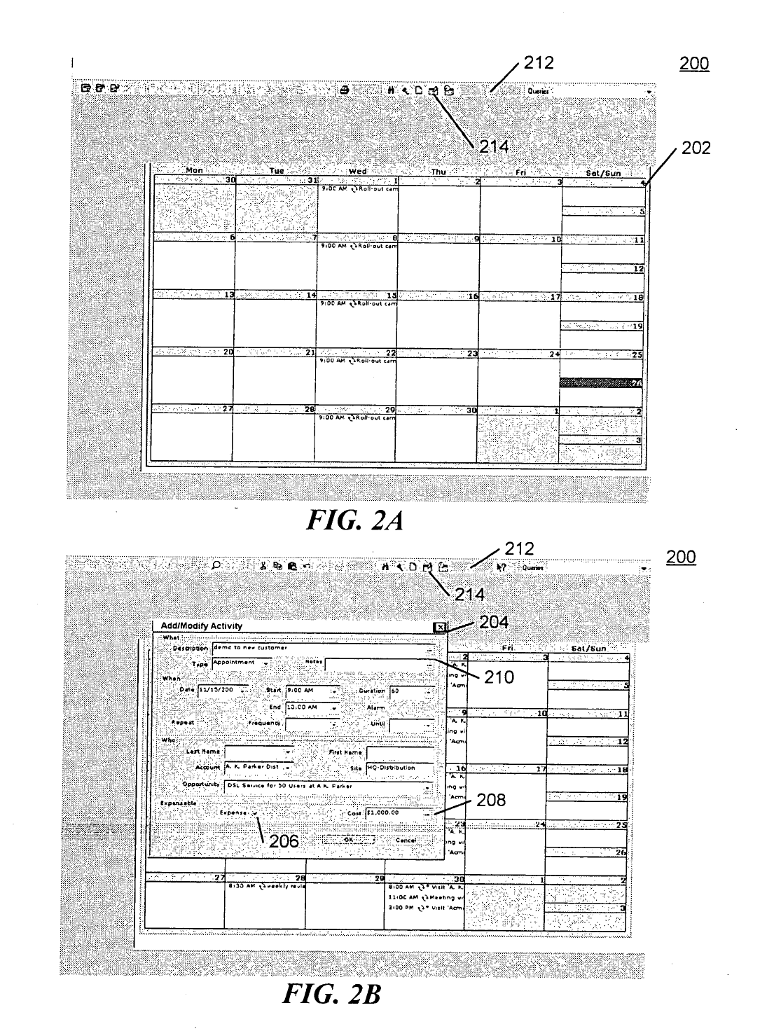

FIG. 2A depicts an exemplary list 200. It should be noted that list 200 is shown for illustrative purposes only, and a list may be anything that includes activity items. Exemplary list 200 is depicted as a calendar for illustrative purposes only, and a calendar is a list in the sense that activity items may be added to particular days and time slots of a calendar. Exemplary list 200 is generated and maintained by Siebel® Sales, a proprietary software application of the assignee of the present patent application. Other well-known activity-item list applications include Act!™, MS Outlook™, Novell Groupwise™, etc.

According to an exemplary embodiment of the present invention, list 200 is displayed to user 112 on client 110, providing interaction with application server 102. As shown, list 200 includes calendar 202, list toolbar, and expense report button 214. In operation, user 112 enters activity items into calendar 202. For instance, a user may select a particular day on calendar 202 into which to enter a new activity item.

FIG. 2B depicts exemplary list 200 further including activity dialog box 204, activity detail box 210, expensable detail box 208, and expensable check box 206. After user 112 has chosen to add an activity item by selecting a day in calendar 202, activity dialog box 204 “pops up.” Activity dialog box 204 provides the interface by which user 112 adds and specifies the details of a new activity item to calendar 202. Activity dialog box 204 includes expensable check box 206, expensable detail box 208, and activity detail box 210. Activity detail box 210 provides the list of available predefined activity items. Once an activity item is selected, and the details provided (e.g., time, date, with whom, etc.), the activity item may be added to list 200, here a calendar.

In order to track expenses associated with activity items, each instance of an activity item can be associated with a number of expense items. An expense item can be anything that has an associated cost. Examples of expense items are hotel bills, airfare, cab fare, entertainment charges, meal bills, etc. When user 112 adds an activity item to list 200, an associated expense item can be included automatically based on an association between the activity item and expense item. For example, if user 112 adds a trip activity item to list 200, a travel expense item that is associated with the activity item can be included.

If an activity item is not already associated with an expense item (i.e., the activity item is non-expensable), user 112 can identify the activity item as expensable by selecting expensable check box 206. At some point after identifying the activity item as expensable, user 112 will be asked to identify those expense items with which the activity item is associated. The present invention contemplates a number of scenario embodiments in which user 112 may specify expense item types associated with a non-expensable activity item. For example, user 112 may create new expense item types and associate them with previously non-expensable activity item, user 112 may choose from among expense item types predefined by application administrator 106, application administrator 106 may define a set of expense item types that user 112 can associated with the non-expensable activity item type, etc. According to an embodiment of the invention, expense items are associated with the activity items in database records of database 104. Application administrator 106 and user 112 may associate various types of expense items with activity items, as described in more detail below. Once the activity item is added to list 200 and associated with an expense item, user 112 can generate an expense report.

Exemplary list 200 also includes expense report button 214. Once user 112 has provided the required or desired activity items, and has identified them as expensable, expense report button 214 may be selected to generate an expense report. When user 112 chooses to generate an expense report, application server 102 collects the relevant expense items (e.g., those associated with a particular date range) from database 104 and generates the expense report. In some cases, the expense items of the expense report may not include all the required information. In such cases, incomplete expense items can be provided to user 112 at client 110 for completion before the report is printed or submitted for approval. An exemplary process by which expense reports are generated is described in further detail below.

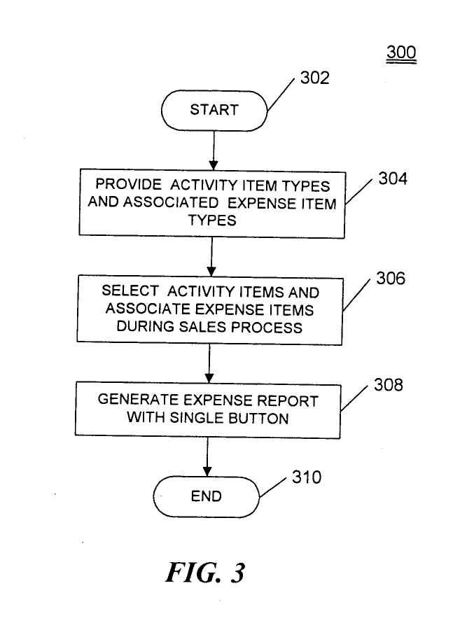

FIG. 3 depicts an exemplary method 300 for automatically generating an expense report. After method 300 starts in step 302, application server 102 provides activity item types and associated expense item types to client 110 via network 108, in step 304. An activity item type is a class of activity, of which any particular activity item is an instance. For example, application administrator 106 can create a new activity item type at application server 102 such as “meeting”, which subsequently stores it in database 104. Once the activity item type is created, user 112 can add instances of the meeting activity item type (i.e., specific meetings), or activity item, to list 200. In an embodiment of the invention, user 112 selects an activity item type, and an activity item is created and added to list 200. Similarly, expense item types are classes, of which any particular expense item is an instance. Application administrator 106 can associate newly created or existing expense item types with the activity item types in database 104. Application server 102 provides the activity item types and expense item types by transmission via network 108 to client 110.

In step 306, user 112 selects activity items on client 110 and adds them to a user list, such as list 200. More specifically, when user 112 chooses to add an activity item to their list, a menu of available activity item types is displayed (e.g., via a dropdown menu). User 112 adds an activity item to the list by selecting one of the activity item types. An activity item may be expensable by default (e.g., expensable check box 206 checked). In such a case, the activity item type is associated with at least one expense item type in database 104. Alternately, the activity item type may not be expensable by default, and user 112 can associate an expense item type with the activity item. The user can, for example, add an expense item type by selecting from a list of available expense item types, or create new expense item types and associated them with the activity item. The list of activity items and associated expense items grows as user 112 adds activity items during the course of business.

In step 308, user 112 generates an expense report by selecting a button at client 110 (e.g., expense report button 214). According to an embodiment of the invention, client 110 provides user 112 with a single button with which to generate an expense report. When user 112 selects the button, application server 102 collects the expense items associated with user 112 into an expense report. The expense report can then be displayed to user 112 for edits, review, printing, or submitting electronically for approval. In an alternate embodiment, a different user, such as an assistant or secretary, application administrator 106, or supervisor generates the expense report by selecting a single button. After the completion of step 308, the method 300 stops in step 310.

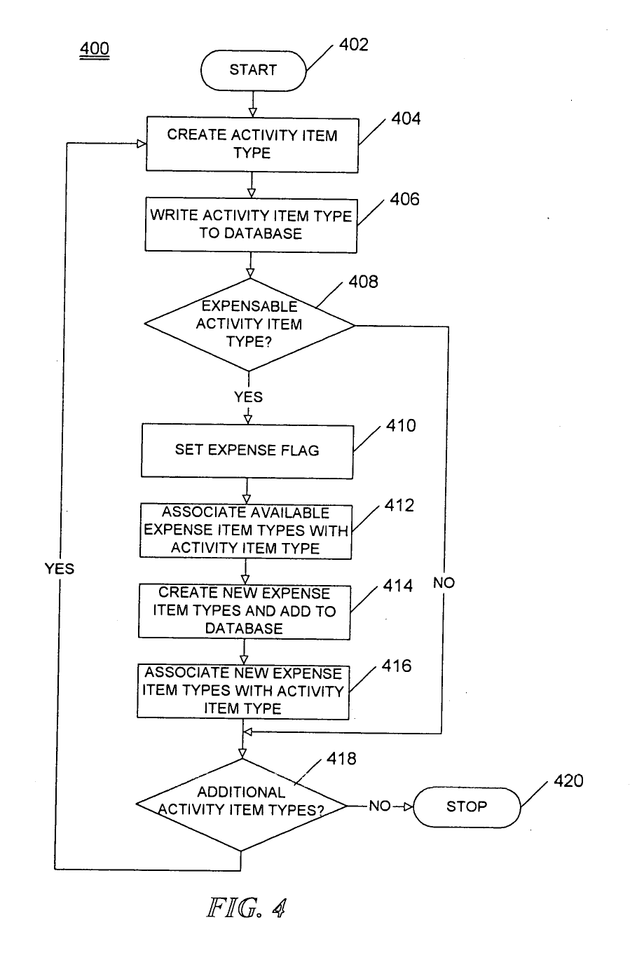

FIG. 4 depicts an exemplary method 400 further illustrating step 304 of method 300, in which application administrator 106 provides activity item types and associated expense item types. After method 400 starts in step 402, administrator 106 creates an activity item type, in step 404. According to an exemplary embodiment, application server 102 displays a form or other user interface that enables application administrator 106 to create an activity item type. Once the new activity item type is created, user 112 is able to add an activity item of this type to a list at client 110, as described above. Examples of types of information included when application administrator 106 creates an activity item type are a description of the activity (e.g., meeting, presentation, trip, etc.), itemized tasks associated with the activity item type, whether the activity item type is associated with a particular client, etc.

Application administrator 106 can also specify whether the new activity item type is “expensable.” If the new activity item type is typically associated with expense item types, application administrator 106 will select an expensable form element, such as a check box, to identify the new activity item type as expensable. Once application administrator 106 creates the new activity item type, application server 102 writes the activity item type to database 104 in step 406. In an exemplary embodiment, application server 102 maintains a database table of activity item types to which the new activity item type is added. In decision step 408, application server 102 determines whether application administrator 106 has identified the activity item type as expensable. If application server 102 determines the activity item type created in step 406 is non-expensable, method 400 continues in step 418. In step 418, administrator 106 indicates whether or not additional activity item types are to be added. If additional activity item types are to be added, method 400 continues in step 404.

If, on the other hand, application server 102 determines that the activity item type is expensable in step 408, method 400 continues in step 410. In step 410, application server 102 sets an expense flag. The expense flag (e.g., a Boolean database field) indicates that a particular activity item type is expensable, and enables application server 102 to quickly determine whether an activity item type is associated with at least one expense item type. It should be noted, however, that an activity item type can be indicated as expensable in other ways, such as a query to database 104 that identifies expense item type records associated with the activity item type, etc.

In step 412, administrator 106 associates available expense item types with the particular activity item type. Expense item types that are associated with the activity item type are automatically collected into the expense report when it is subsequently generated. In an exemplary embodiment, database 104 includes a table of expense item types, each of which is associated with a key field. Activity item type records in database 104 can include fields that include key values identifying associated expense item types, as would be apparent. Consider, for example, the case in which application administrator 106 adds an activity item type for travel. Application administrator 106 then associates an expense item type of “airfare” with the activity item type at application server 102. Subsequently, when user 112 chooses to add a travel activity item to list 200, user 112 can also add an airfare expense item.

In step 414, application administrator 106 can create new expense item types as needed or desired. To add a new expense item type, a record is created in database 104, and application administrator 106 provides detail information to the record associated with the new expense item type. Then, in step 416, administrator 106 associates the newly created expense item types with the activity item type, in a manner as described above in conjunction with step 412. It should be noted, however, that steps 414 and 416 are performed as new expense item types are needed, and not necessarily everytime application administrator 106 adds an activity item type. In decision step 418, application administrator 106 decides whether to add additional activity item type to database 104. If additional activity item types are to be added, method 400 continues in step 404. If, on the other hand, no additional activity item types are to be added to database 104, method 400 stops in step 420.

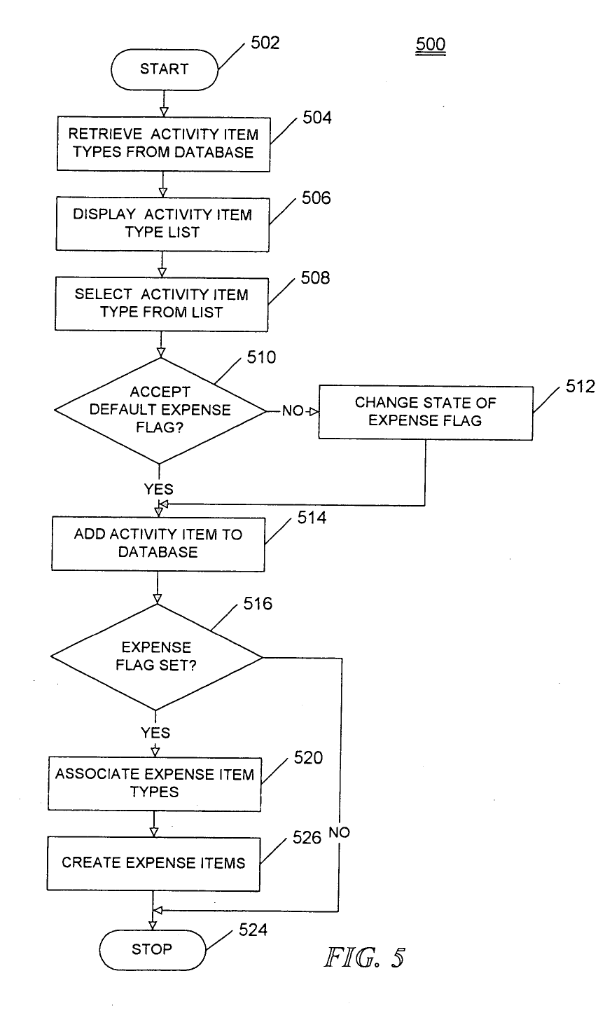

FIG. 5 depicts an exemplary method 500 further illustrating step 306 of method 300, in which user 112 selects activity items and their associated expense items. After method 500 starts in step 502, client 110 retrieves activity item types from database 104, in step 504. The activity item types can be retrieved from database 104 in any number of ways. For example, if user 112 has chosen to add an activity item to a list of activity items at client 110, client 110 formulates a request and transmits the request to application server 102 via network 108. Application server 102 then queries database 104 for activity item types and transmits them to client 110. In an alternate embodiment, application server 102 can transmit the selection of available activity item types with the list displayed to user 112 at client 110.

In step 506, client 110 displays an activity item type list to user 112 (e.g., when user 112 has chosen to add an activity item to a list, such as list 200). In step 508, user 112 selects one of the activity item types from the activity item type list. In an exemplary embodiment, once user 112 selects the activity item type, a dialog box, such as activity dialog box 204, is displayed on client 110. The dialog box enables user 112 to specify details associated with the particular activity item. For example, user 112 can add an appointment activity item to the list, and then specifies the details of the appointment, such as time, location and party of the appointment, etc.

In an exemplary embodiment, the dialog box includes a form element, such as expensable check box 206, indicating the state of the expense flag associated with the activity item type. In decision step 510, user 112 decides whether or not to accept the state of the expense flag. If application administrator 106 has not originally identified an activity item type as expensable and associated it with an expense item type, it will appear as non-expensable by default (e.g., in expensable check box 206). If the activity item type is non-expensable by default, user 112 can select the form element to indicate that the activity item type is expensable. Likewise, if the activity item type is expensable, user 112 may deselect the form element to indicate the activity item type is non-expensable.

If user 110 decides not to accept the default expense report flag associated with the activity item type selected from the list, method 500 continues in step 512. In step 51.2, the state of the expense flag is changed and method 500 continues in step 514. If, on the other hand, the user decides to accept the state of the expense flag, method 500 continues in step 514.

In step 514, application server 102 adds the activity item to database 104. For example, when user 112 selects the activity item type, the activity item type is transmitted from client 110 via network 108 to application server 102, where an instance of the activity item type is added to database 104. According to an exemplary embodiment, database 104 includes a table including the activity items associated with user 112, as would be apparent.

In step 516, application server 102 determines whether or not an expense item is to be associated with the activity item, as indicated by the expense flag. If the activity item type is expensable (i.e., the activity item type is to be associated with an expense item type), the process of method 500 continues in step 520.

In step 520, user 112 is provided with the opportunity to associate expense item types with the activity item type of step 508, such as through an interface that allows expense item types to be associated with the activity item type and stored in database 104. User 112 may wish to associate expense item types if the default expense flag was changed from non-expensable to expensable in step 512. An example of the circumstances under which user 112 may wish to associate expense item are incurred expenses not anticipated by application administrator 106. In an exemplary embodiment, user 112 is provided with the opportunity to associate multiple expense item types in step 520. User 112 may wish to select more than one expense item type if, for example, multiple expenses are associated with a particular activity item (e.g., both airfare and cab fare associated with a trip).

In step 526, the instances of the expense item types that are associated with the activity item are created. The newly created expense items are associated with the activity item from step 508 and stored in database 104. It should be noted that although steps 520 and 526 are depicted as occurring contemporaneously with step 514, in implementation, steps 520 and 526 can occur anytime before the expense report is completed. After step 526, method 500 stops in step 524.

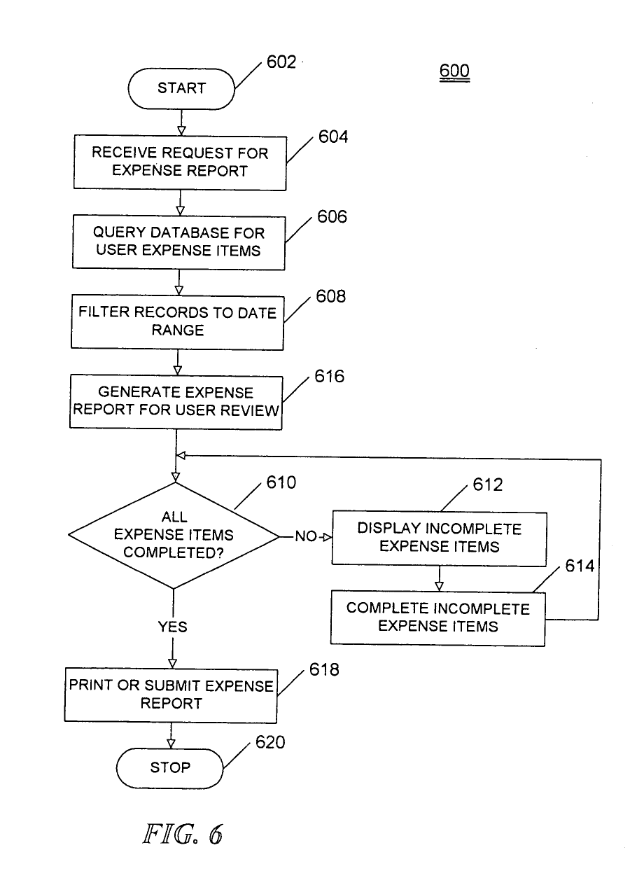

FIG. 6 depicts an exemplary method 600, further illustrating step 308 of method 300, in which system 100 generates an expense report in response to user 112 selecting a single button. After method 600 starts in step 602, application server 102 receives a request for an expense report, in step 604. The request can come from user 112 at client 110, from application administrator 106 at application server 102, or some other device included in system 100. Alternatively, the request can be a scheduled batch routine or some other automated process. In an exemplary embodiment, the request identifies a user or users for whom, and a date range over which, the expense report is to be generated.

In step 606, application server 102 queries database 104 for user expense items. User expense items are the expense items created in step 526 of method 500 and associated with the user or users identified in the request. The query results in a collection of expense items associated with the user. In step 608, application server 102 filters the resultant set of user expense items returned from query step 606 to the date range identified in the request. A particular date range establishes the period for which the expense report will be generated. For example, user 112 may have added several years worth of expense items to a list on database 104. Filtering the expense items for a particular date range allows system 100 to generate an expense report including expense items for the past week, two weeks, month, etc. After a set of user expense items have been identified, method 600 continues in step 616.

In step 616, application server 102 generates an expense report for the review of user 112. The user expense items, and the associated expense item detail information collected and filtered in steps 606 and 608 is retrieved from database 104 and written to a report, as is known in the art. The format of the report, the particular data items associated with the expense items, etc. are dependent on the particular environment and requirements of user 112 or application administrator 106. After step 616, method 600 continues in step 610.

In decision step 610, user 112 determines if the expense items in the report are completed. According to an embodiment of the present invention, the expense report generated in step 616 may not include all of the expense detail information, such as amounts and particular establishments associated with the expenses (e.g., airlines, cab companies, hotel companies, etc.). Completed expense items include the information needed, such as expense amount, location, establishment, etc., to generate a completed expense report. If user 112 determines that some of the expense items require additional information for completion, method 600 continues in step 612. In step 612, client 110 displays any incomplete expense items to user 112. In an exemplary embodiment, the incomplete expense items are displayed to user 112 via a form, such as a form for data entry. In an alternate embodiment, application server 102 may check the expense items in the report in step 610, using data validation techniques as are known.

In step 614, the user selects the incomplete expense items and provides information to complete them. User 112 provides the data to complete the expense item or items, and submits it to application server 102. The completed expense item and associated information is written back to database 104 and included in the expense report, after which method 600 continues in step 610. Once the expense items include the necessary information, method 600 continues in step 618.

In step 618, the resultant expense report is printed or submitted for review within the organization. Since the report is generated automatically, it can be sent electronically to other users in the organization for approval, or stored indefinitely on system 100.

In an alternate embodiment, the expense items are created and associated (as in steps 520 and 526 of method 500, described above) after application server 102 receives a request for an expense report (i.e., step 604). In this embodiment, application administrator 106 creates and associates the expense item types with activity item types, as in step 416 of method 400. User 112 adds instances of the activity item types (i.e., activity items) to a list, such as a calendar, or list 200, and they are stored in database 104. When application server 102 receives a request for an expense report, the activity items for the user and date range identified in the request are collected from database 104.

In some cases, user 112 will have identified activity items as expensable that were not originally defined as expensable by application administrator 106 by selecting a form element, such as expensable check box 206 in step 526 of method 500. In such cases, client 110 presents user 112 with a dialog box enabling the user to specify an expense item to associate with the activity item. After user 112 specifies the expense item, the expense report can be generated. Application server 102 generates the expense report by creating all of the expense items associated with the activity items collected from the database and writing them into a report, as in step 616 of method 600. User 112 completes incomplete expense items, and prints or submits the report, as in steps 612, 614, and 618 of method 600.

Those of skill will appreciate that the above described functionality can be implemented across a wide array of platforms using a wide array of computer program logic. Any combination of computer logic, such as hardware, firmware, and software may be used to implement the functionality. Examples of the types of computer logic that can be used include C++, VisualBasic™, Java™, and C programming languages, Hypertext Markup Language (“HTML”), client and server side scripting, etc. Additionally, the above described functionality may be deployed over the World Wide Web (“WWW”) to a browser as a network based application using various HTML, JavaScript, server-side and client-side programming, and other network program logic, as would be apparent.

Although the present invention has been discussed above in reference to examples of embodiments and processes, other embodiments and/or processes are possible. For example, although FIG. 1 illustrates a single system 100 and various coupled entities (such as, for example, application server 102, database 104, network 108, clients 110, etc.), other configurations are possible. For example, rather than a single network, multiple networks interconnected by the appropriate network gateways, routers and/or bridges are possible. Similarly, the various entities coupled to the network can be coupled through other arrangements, such as through additional associated networks, gateways, etc.

For another example, although the discussion above referenced a client-server configuration, other embodiments of the present invention can have a client-client configuration. In such a client-client configuration, the method described above in reference to FIGS. 3-6 can be performed, at least in part, at a particular client-side entity rather than at a centralized client-server system. For example, the steps of providing activity item types and associated expense item types, selecting activity items and associated expense items, generating expense report, and many other steps, can be performed on a client-side entity so that an expense report is generated at a client-side entity, such client 110 discussed above.

It will be apparent to one skilled in the art that various changes and modifications can be made therein without departing from the spirit and scope thereof. Thus, it is intended that the present invention cover the modifications and variations of this invention provided they come within the scope of the appended claims and their equivalents.

1. A method in a computing system for generating an expense report, comprising:
displaying controls including a first button and a second button;
in response to each activation of the first button:
creating a new activity item;
establishing a user-selected activity type for the created activity item;
creating an expense item;
consulting a predetermined mapping from activity types to expense types to automatically establish an expense type for the created expense item;
setting an unreported flag for the created expense item; and
in response to each activation of the second button, without any user input to the process of creating an expense report subsequent to the activation of the second button:
creating a new expense report;
for each created expense item having a set unreported flag:
adding the created expense item to the created expense report;
clearing the created expense item's unreported flag; and
submitting the created expense report containing the added created expense items.

2. The method of claim 1, further comprising, in response to each activation of the first button:
establishing for the created activity item a date designated by a user for the activity item; and
without user input specifying a date for the created expense item, establishing for the created expense item the same date designated by a user for the activity item.

3. A computer-readable medium whose contents cause a computing system to perform a process for generating an expense report, comprising:
displaying controls including an activity item creation button and an expense report creation button;
in response to each activation of the activity item creation button:
creating a new activity item;
establishing a user-selected activity type for the created activity item;
creating an expense item;
consulting a predetermined mapping from activity types to expense types to automatically establish an expense type for the created expense item;
setting an unreported flag for the created expense item; and
in response to each activation of the expense report creation button, without any user input to the process of creating an expense report subsequent to the activation of the expense report creation button:
creating a new expense report;
for each created expense item having a set unreported flag:
adding the created expense item to the created expense report;
clearing the created expense item's unreported flag; and
submitting the created expense report containing the added created expense items.

4. The computer-readable medium of claim 3 wherein the process further comprises, in response to each activation of the activity item creation button:
establishing for the created activity item a date designated by a user for the activity item; and
without user input specifying a date for the created expense item, establishing for the created expense item the same date designated by a user for the activity item.

5. A computing system for generating an expense report, comprising:
a control display subsystem that displays controls including a first button and a second button;
a first button activation processing subsystem that, in response to each activation of the first button:
creates a new activity item;
establishes a user-selected activity type for the created activity item;
creates an expense item;
uses a predetermined mapping from activity types to expense types to automatically establish an expense type for the created expense item;
sets an unreported flag for the created expense item; and
a second button activation processing subsystem that, in response to each activation of the second button, without any user input to the process of creating an expense report subsequent to the activation of the second button:
creates a new expense report;
for each created expense item having a set unreported flag:
adds the created expense item to the created expense report;
clears the created expense item's unreported flag; and
submits the created expense report containing the added created expense items.

6. The computing system of claim 5, further comprising a date designation system that, in response to each activation of the first button:
establishes for the created activity item a date designated by a user for the activity item; and
without user input specifying a date for the created expense item, establishes for the created expense item the same date designated by a user for the activity item.

7-12. (canceled)
